(19) United States
(12) Patent Application Publication
(10) Pub. No.: US 2018/0375965 A1
(43) Pub. Date: Dec. 27, 2018

(54) Packaged Product Configuration

(71) Applicant: The Chamberlain Group, Inc., Oak Brook, IL (US)

(72) Inventor: James J. Fitzgibbon, Batavia, IL (US)

(21) Appl. No.: 15/629,304

(22) Filed: Jun. 21, 2017

(51) Int. Cl. H04L 29/06; G08C 17/02; G06K 7/10; G06K 19/07

(52) U.S. Cl. CPC H04L 69/03; G08C 17/02; G08C 2201/21; G06K 19/0723; G06K 7/10366

(57) ABSTRACT

A packaged apparatus includes a wireless communication device capable of communicating via a variety of different communication protocols. The communication device can be adapted to communicate according to one particular communication protocol from within the package and without physical access to the device. Accordingly, the configuration of the communication device can take place after packaging and either before, during, of after shipment of the product. The packaged apparatus communicates with an external device, reads, or receives information from the external device and then configures the communication device based on the read or received information. The external device can be an identification tag read by a reading device within the package, or it can be a transmitter that transmits signals that can be read by a communication device internal to the package.

### TECHNICAL FIELD

This application relates to packaged products and related packaging and configuration techniques. More specifically, this application relates to packaged products with wireless communication devices that can be configured from outside of the package.

### BACKGROUND

Regulatory agencies dictate the mode or protocol by which wireless communication devices communicate. Agencies in various regions or jurisdictions may establish regulations that control the particular protocols for particular wireless communication devices. For instance, agencies may establish particular radio frequencies for which certain types of radio controllers should operate to avoid interference among similar signals over local airwaves. To comply with these regulations and protocols, products containing the regulated communication devices may be particularly tailored or configured so that they properly operate in accordance with the established protocols of the region where the products are sold. For example, movable barrier operators (e.g., garage door operators) may need to operate at one particular protocol if it is to be used within the United States, but at another particular protocol if it is to be used in other countries in Europe or other locations.

Products that are provided among regions having different communication regulations are typically configured before they are finally packaged. Such products are carefully marked or tracked to assure that the proper model types are distributed to the proper geographic region. However, this can result in model proliferation and coordination problems at the manufacturing and distribution facilities.

### SUMMARY

This application relates to packaged products and methods for configuring the products after packaging. The packaged products have communication devices that are capable at communicating among a variety of different communication protocols. For example, the packaged communication devices may be capable of communicating via protocols that are suitable for operation in each of a variety of different geographic regions or jurisdictions that use different communication protocols. The described methods and products allow for the configuration to take place after the product is packaged. That is, the configuration can take place without having direct access to the product itself.

In one aspect, the packaged product includes a reading device that is capable of detecting communicating with identification devices that may be placed on or around the package. The reading device scans for the identification device, for example, by periodically (e.g., once a minute, once a second, etc.) broadcasting signals adapted to communicate with the identification device. When the reading device detects the presence of an identification device, control circuitry configures the communication device to operate in accordance with a particular communication protocol based on information obtained from the identification device. For instance, the identification device may be encoded with information relating to a particular communication protocol. When the reading device detects the identification device, it reads the encoded information and stores related information on a storage device. When it is time to configure the communication device (which can be instantly, when the device is unpackaged by a user, upon installation of the product, or at some other time), the control circuitry configures the communication module to use a protocol based on the information most recently stored ion the storage device. In this manner, a manufacturing facility can manufacture and package a number of products without configuring the communication devices. The packaged products can then be taken to particular distribution centers for shipment to the intended end location. The packaged products can thus be configured at various stages by placing the proper identification devices (e.g., tags encoded with information identifying a particular communication protocol) on or around the packages (i.e., within the communication range of the reading device). For example, the packaged products can be configured prior to shipment, during shipment, or even after the shipped packages are received at the end destination, as convenient for the process.

In another aspect, the packaged product includes an internal communication device within the package that is capable of communicating with an external communication device external to the package. For instance, the internal communication device may be adapted to receive wireless signals (e.g., radio signals) transmitted from the external communication device (e.g., a radio transmitter) through the packaging. The wireless signals contain information pertaining to a particular communication protocol. Control circuitry within the packaging can then configure the communication device to operate according to the particular communication protocol relating to the last signal received prior to configuration. In this way, the control circuitry can configure a package before, during, or after shipment, by pointing or waiving an external communication device about the exterior of a package (or a collection of multiple packages), and sending signals to the internal communication device within the package with information relating to the communication protocols. When a user un-packages the product and puts the communication device into operation, the communication device will be configured to operate according to the particular communication protocol.

### BRIEF DESCRIPTION OF THE DRAWINGS

The attached figures depict diagrams and images of components of a security system in accordance with at least one example of the present disclosure.

FIG. 1 shows a flow diagram of various stages of the life of a packaged product from assembly to installation.

FIG. 2 is a block diagram showing a packaged apparatus in communication with an identification device in accordance with examples described herein.

FIG. 3 shows the apparatus of FIG. 2 and various components associated with the apparatus.

FIG. 4 shows a packaged apparatus in relation to an identification device in accordance with examples described herein.

FIG. 5 shows the packaged apparatus of FIG. 4 on a skid or pallet with a number of other similar packaged apparatuses.

FIG. 6 is a block diagram showing a packaged apparatus in communication with an external communication device accordance with examples described herein.

FIG. 7 shows the apparatus of FIG. 6 and various components associated with the apparatus.

FIG. 8 shows a packaged apparatus interacting with an external communication device in accordance with examples described herein.

FIG. 9 shows the packaged apparatus of FIG. 8 on a skit with a number of other similar packaged apparatuses.

FIG. 10 is a flow diagram for a method of configuring a packaged apparatus in accordance with examples described herein.

FIG. 11 is a flow diagram for another method of configuring a packaged apparatus in accordance with examples described herein.

### DETAILED DESCRIPTION

This application describes packaged products and methods for configuring the packaged products while they are in the product packaging. More specifically, this application relates to the in-package-configuration of wireless communication devices (e.g., radio transceivers) so that the communication devices communicate according to a particular communication protocol. The communication devices are capable of communicating via a variety of different communication protocols. For instance, the communication devices may be configured to communicate at radio frequencies regulated for use in the United States for the control of remote devices, and they may also be configured to communicate at different radio frequencies that are regulated for use throughout regions in Europe, China, Latin America, Australia, or others. Because the products are capable of being configured while they are in the package, it alleviates the burden of having to keep track of each of the separately configured products from pre-packaging through shipment. That is, products can be assembled, packaged, and taken to distribution facilities without concern for keeping products segregated by their communication protocol. At a desired location, for example, at the distribution facility, the packaged products that are being shipped to specific locations can be configured, in their packages, in accordance with the protocols of the destination region.

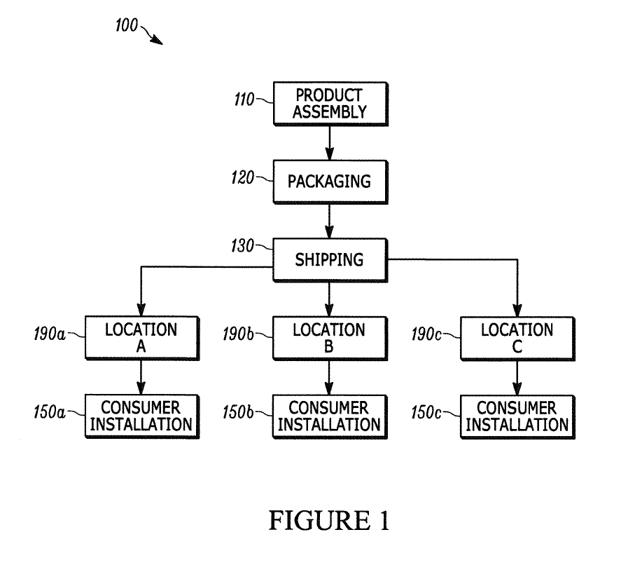

FIG. 1 is a flow diagram of a generic method 100 for manufacturing and distributing products. Products are built, manufactured, and/or assembled 110 at a manufacturing facility. After assembly the product is placed in packaging 120, such as a box or plastic wrapping. The packaged product is then taken to a distribution center where the packaged products can be shipped 130 or distributed to various end locations 140n, which may be retail stores, warehouses, or other facilities, for example. Consumers purchase the packaged products, remove the products from their package, and install the products 150n as appropriate.

In some cases, products shipped by the method 100 include configurable components. That is, the packaged products may have equipment that can be configured to operate in accordance with a variety of different protocols. For instance, the products may have wireless communication equipment that is capable at communicating (e.g., sending and listening for signals) at a variety of different wireless frequencies. Which particular protocol the equipment ultimately uses may be dictated by local regulations and requirements. For example, home wireless communication equipment for sale in one geographic region (e.g., the United States) may be required to operate within a first particular radio frequency range, so as not to interfere with other communication signals over airwaves within that geographic region. However, that same home wireless communication equipment may be capable of operating within a second particular radio frequency range in case that equipment ends up in a second geographic region that requires communicating within that second radio frequency range.

Configuring the products can be complicated and confusing to many end users. Accordingly, it can be desirable to have the products already pre-configured prior to the end user's purchase or installation of the product. Because typical configuration methods involve directly or physically manipulating or otherwise altering the products themselves, this configuration often occurs during or immediately after the product assembly, and before packaging of the product. That is, the configuration must typically take place before the packaging step 120 of the method 100. However, this pre-packaging process can present burdens on the manufacturing process because it requires the configured products to be specifically marked, tracked, or otherwise observed from the post-assembly production through shipping. That is, if the products are not properly marked and/or tracked, products configured for operation in one geographic region may be accidentally shipped to another region where they their communication protocol regulations would render the improperly configured product inoperable by the end users. Moreover, pre-configured products that are erroneously or accidentally transported to the wrong geographic region cannot be easily re-configured without removing the products from their packaging. In such situations the products may need to be returned to the distribution centers or transported to the proper facilities.

This application relates to the configuration of products, in particular, communication devices, after the products are packaged. The present application describes techniques and products that allow the packaged communication devices to be configured, and reconfigured, after packaging 120, and either before, during, or after shipment 130. The packaged product includes a wireless communication device that is capable of communicating via a variety of different communication protocols. For example, the wireless communication device may be configured so that it operates in one of a variety of different wireless radio signal frequency ranges, such as, for example, 300 to 500 MHz and/or 900 to 1000 MHz.

The packaged product can be configured using a variety of different techniques. These techniques involve utilizing a communication component within the package that is separate from the communication device to be configured. This communication component communicates with equipment outside the package (e.g., tags, readers, scanners, transmitters, etc.), and receives information about how the communication device should be configured. A controller or control circuitry associated with the packaged product controls the operation of the communication device, and configures the communication device to communicate according to the particular communication protocols based on the information received from the exterior equipment. The present application contemplates a variety of different approaches and embodiments to address this in-package configuration.

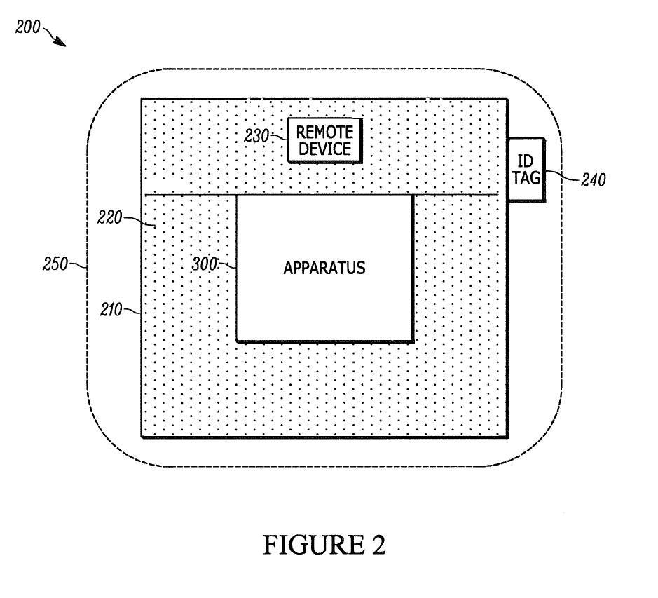

One approach for configuring a packaged product is shown with respect to FIGS. 2-5. Specifically, FIG. 2 shows a block diagram of a package 200 housing an apparatus 300 that can be configured from within the package. The package 200 includes a package housing 210, which can be a box or a container, a plastic wrapping, or other conventional package products. As shown in FIG. 2, the apparatus 300 may be fully enclosed within the package housing 210; however, it should be appreciated that only a portion of the apparatus 300 may be within the package housing 210. For example, the apparatus may include pieces or accessories that extend beyond the boundary of the package housing. Such partially-enclosed products should still be considered to be “within a package housing” as used throughout this application.

The package 200 includes a remote device 230 within the package housing 210 along with the apparatus 300. The remote device may include, for example, a remote controller that can be used to control operation of the apparatus 300 upon installation. For instance, the apparatus 300 may include a movable barrier operator (e.g., a garage door opener) that operates a barrier between open and closed positions at a building entryway (e.g. a garage door), and the remote device 230 includes a remote control device adapted to communicate with and control the barrier operator using wireless signals (e.g., radio signals). In some forms, the remote device 230 can be a wall mountable interface that is capable of communicating with a variety of components, including the apparatus 300, via a network. In other examples, the remote device 230 can be a sensor, such as a motion sensor, obstacle sensor, or a light sensor that relays information to the apparatus 300. The package 200 may include some packaging materials 220 such as packaging foam, bubble wrap, cardboard separators, tape, molded plastic supports, and the like, to provide structural support to the components within the package 200.

Exterior to the package is an identification device, or an ID tag 240. The identification device 240 may include be a radio frequency identification (“RFID”) tag that can communicate with other RFID equipment, such as an RFID reader, that may be a part of the apparatus 300 within the package 300. The identification device 240 is encoded with information, and is adapted to transmit that information wirelessly, for example, to a corresponding communication device that is adapted to communicate with the identification device 240, such as an RFID reader. For instance, the apparatus 300 within the package 200 may be equipped with a reading device, such as an RFID reader, that is adapted to detect and communicate with the identification device 240 when the identification device is placed within a communication region 250 of the package 200.

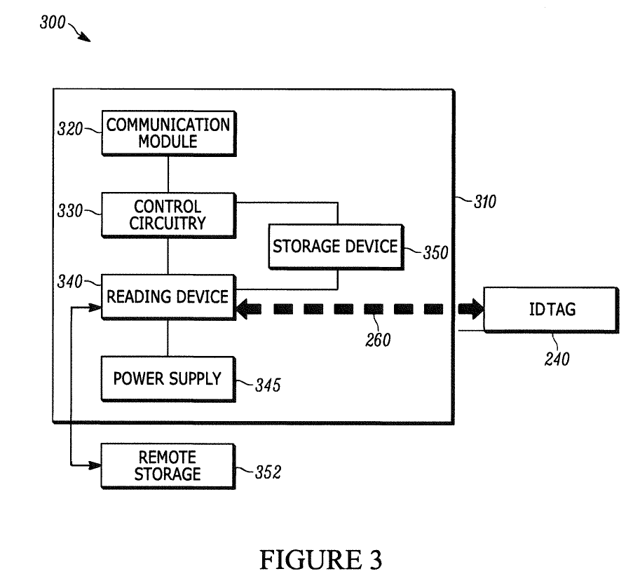

FIG. 3 shows a block diagram of an exemplary apparatus 300 that may be placed in the package 200 in accordance with certain embodiments of the present application. The apparatus includes a communication module 320, control circuitry 330, a reading device 340, a power supply 345, and a storage device 350. The components of the apparatus 300 may be within an apparatus housing 310. The apparatus 300 may include additional components, including an additional power supply, such as an AC power supply connector, a DC power supply connector, a battery, or the like.

The communication module 320 can be a device that is capable of communicating wirelessly with other remote devices, such as the remote device 230 (e.g., remote controls, sensors, wall mounted interfaces, etc.), a wireless network, the internet, cellular devices, or the like. The communication module 320 may be capable of communicating via one or more of wireless radio signals, cellular signals, optical signals, Bluetooth, electromagnetic induction, sonic or ultrasonic signals, or other wireless protocols. In still other examples, the communication module 320 may be capable of communicating via wired communication protocols.

The communication module 320 is also capable at communicating according to more than one protocol, and can be configured to communicate at one particular protocol among a variety of different protocols. For instance, the communication module 320 may be capable at communicating one or more of a first frequency range, a second frequency range that is different from the first frequency range, and a third frequency range that is different from the first and second frequency ranges. The module 320 can thus be configured so that when it does communicate, it uses one particular frequency range.

The control circuitry 330 is in communication with the communication module 320 and the reading device 340, and may further be in communication with the storage device 350 and other components of the apparatus. The control circuitry 330 can configure the communication module 320 to communicate at one particular communication protocol (or a subset of protocols) that are among the variety of communication protocols that the module 320 is capable of using. In some examples, the control circuitry 330 can modify the communication protocol that the communication module 320 uses. For example, the control circuitry may periodically switch the protocol of the communication module 320 in response to receiving updated or revised information.

The control circuitry may 330 also be capable of operating other functionality of the apparatus 300. For instance, where the apparatus 300 is a movable barrier operator, the control circuitry may be adapted to control movement of the barrier between open and closed positions in response to information received from other sources such as the remote device 230, or other sensors or remote equipment.

The reading device 340 is in communication with the control circuitry and one or more storage devices, such as the local storage device 350 and a remote storage device 352. The local storage device 350 may be a component of the reading device 340. The local storage device 350 can include a data storage device such as a hard drive, a random access memory device, read only memory device, a flash drive, an SD card, or the like. The reading device may also be adapted to communicate with a remote storage device 352 wirelessly, for example, through a network such as the internet or via other wireless communication techniques (e.g., Bluetooth). In some forms, the remote storage device 352 can include a cloud based storage device, or a network-based computing device.

The reading device 340 also includes equipment that communicates with other remote communication devices, including devices that may be exterior to the package 200. In some forms, the reading device 340 can be an RFID reader that scans or “listens” for other RFID tags (e.g., passive RFID tags, active RFID tags, read-write RFID tags, etc.). The reading device 340 may be adapted to scan by sending periodic radio signals 260 adapted to communicate with a corresponding identification device. In essence, the reading device 340 scans, listens, or otherwise attempts to communicate with a corresponding identification device 240 exterior to the product housing 310. When a corresponding identification device 240 is within the communication range 250 of the reading device 340 (e.g., within a radius of three inches, one foot, three feet, five feet, etc.) the identification device 240 returns a signal so that the reading device 340 detects the identification device 240. The reading device 340 and the detected identification device 240 may then establish a two-way line of wireless communication 260, whereby the reading device 340 can read, download, or otherwise receive the information encoded on identification device 240. The reading device 340 can then store information on a storage device, such as the local storage device 350 or a remote storage device 352.

The reading device 340 is connected to a local power supply 345 that allows the reading device 340 to continuously scan for the identification device 240. The power supply 345 can take on various forms, including the form of a battery that is a component of the reading device 340 itself. The power supply 345 may be different from other power supplies associated with the apparatus 300, and may include a dedicated power source that is only for the reading device 340. In some formats, where the reading device 340 is designed to operate while the apparatus 300 is within the package 200, the reading device may need to maintain a steady draw of electrical power sufficient to maintain a continuous scanning operation without relying on AC power or other external power supplies. In some embodiments, the power supply 345 is adapted to operate the local storage device 350. And in some formats, the power supply 345 may also supply electrical power to the control circuitry 330, for example, so that the control circuitry 330 can recognize when information is stored or written onto the storage device 350.

An apparatus 300 may remain within a package 200 for indefinite periods of time, during which time the reading device 340 will continuously scan or listen for exterior identification devices 240. Accordingly, the power supply 345 may be adapted so that the reading device 340 will be able to continuously scan or listen for extended periods of time. The amount of power in the power supply 345 may depend on a number of factors including the expected time between packaging configuration of the apparatus, the communication range 250 of the reading device 340, the frequency at which the reading device 340 sends out periodic broadcast signals, and the expected time that an identification device 240 will be within the communication range 250 of the reading device 340. The power supply 340 can be adapted to optimize suitable product reliability in view of these factors. For instance, where the intended use of the product is for an identification device 240 to be placed on or near a package 200, and left there indefinitely, the reading device 340 may be adapted to transmit broadcast signals with a relatively low frequency (e.g., once per minute, once every 5 minutes, once every hour, etc.) as a way to conserve power usage. However, where the intended use is for an identification device 240 to be temporarily waved about the package 200 for a brief period, then the reading device 340 may be adapted to transmit broadcast signals with greater frequency (e.g., one or more times per second), and thereby provided with a larger power supply 345.

Moreover, the power supply 345 is also adapted to account for the size of the communication range 250 necessary for the particular package. For instance, where the package 200 is relatively large, or where the reading device 340 is adapted to detect identification devices on a skid or pallet containing multiple packages 200, then the communication range 250 may be relatively large (e.g., two feet, five feet, ten feet, etc.), and the reading device will be adapted to transmit signals with a magnitude sufficient for communicating over that relatively large range, thereby drawing more power from the power supply 345. Conversely, where the package 200 is relatively small, and where the identification device 240 is expected to be relatively close to the reading device 340, the reading device 340 can be adapted to broadcast signals of a smaller magnitude, thereby drawing less power from the power supply 350.

In operation, a packaged (and un-configured) apparatus 300 will continuously and periodically send out broadcasting signals via the reading device 340 from within the package housing 210. After packaging, a distributor can decide where the package is to be shipped, and based on the shipping destination, which communication protocol to use for the apparatus 300. The distributor can then take a particular identification device 240 that is encoded with information associated with that particular communication protocol, and place that identification device 240 within the communication range 250 of the reading device 340 within the package 200. The reading device 340 will detect the presence of the identification device 240 and establish a two-way communication link 260 between the reading device 340 and the identification device 240. The reading device 340 will then read the information encoded on the identification device 340 and store information associated with the particular communication protocol on a storage device 350 (or in some cases, on the remote storage device 352). Subsequently, the control circuitry 330 will configure the communication module 320 to operate in accordance with the particular communication signal protocol that was most recently stored on the storage device 350. In some embodiments, the control circuitry 330 may only configure the communication module 320 upon the initial set-up or installation of the apparatus 300. For instance, the control circuitry 330 may only configure the communication module 320 after an end user removes the apparatus 300 from the package 200 and connects the apparatus 300 with an external power supply. Upon being connected with the external power supply, the control circuitry 330 can read the storage device 350 (or remote storage device 352), and configure the communication module 320 based on the information therein.

In some cases, the reading device 340 may detect the presence of a second identification device 240 after previously detecting a first identification device 240. And in some situations, the identification device 240 might be reprogrammed or re-encoded while it is within the communication range 250 of the reading device 340. In these situations, the reading device 340 and the storage device 350 can be adapted to write over the previously stored information with the new or additional information encoded on the second or reprogrammed identification device 240. Upon set-up, the control circuitry 330 will configure the communication module 320 based on the information most recently written onto the storage device 250.

As noted above, the identification device 240 may be a writable device that can be reprogrammed or re-encoded with information periodically. In some embodiments, the identification device can be a fixture of the package itself. For instance, the identification tag 240 can be embedded into the package housing such that it is always within the communication range of the reading device 340. In this manner, rather than placing a new identification tag 240 within the range of the package to provide the information regarding the particular communication protocol, the identification tag can be written or encoded with the appropriate information at the appropriate time. For instance, a user may wave an active transceiver about the identification device 240 to transmit a signal that reprograms the identification device 240. Upon scanning for the identification device 240, the reading device 340 will detect that identification device 240 has been modified, and update the storage device 250 accordingly.

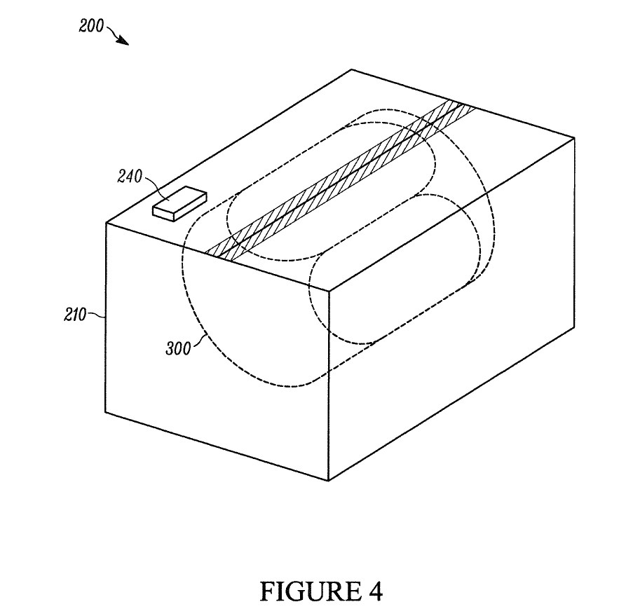

FIG. 4 shows an example of a package 200 in accordance with the examples described above. The package 200 includes an apparatus 300 (shown in broken lines) inside of a package housing 210, which in this embodiment is a box. An identification device 240 (e.g., an RFID tag) is placed on or around the package 200, for example, on the package 200 itself. The identification device 240 can be a passive RFID tag that receives power from an electromagnetic signal generated by the reading device of the apparatus 300. When the identification device 240 is placed in proximity of the package (specifically, within the communication range 250 of the reading device 340), the reading device will detect the identification device 240, read the encoded information pertaining to the particular communication protocol, and store information on the storage device 350 so that the control circuitry 330 can configure the communication module 320 to operate accordingly.

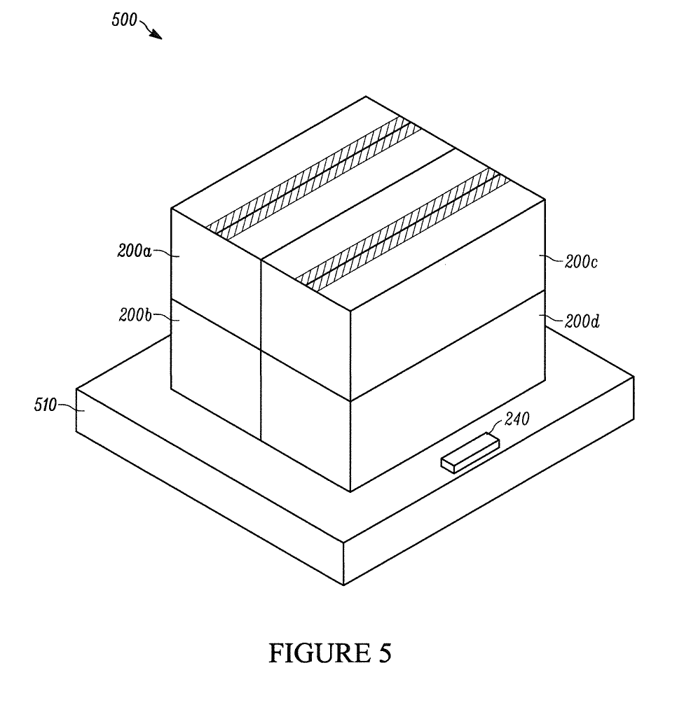

In some examples, multiple packages containing similar or identical apparatuses may be placed on a skid or pallet destined for shipment to a common location that utilizes a particular communication protocol. In such a situation, it can be effective to configure the individual apparatuses on the skid collectively. FIG. 5 shows an example of a skid 500 comprising multiple packages 200n. In this example, four packages 200n, each of which contain similar or identical apparatuses (e.g., each package 200n contains the same product and model), are resting on a platform 510 or pallet. An identification device 240 is placed on or around the packages 200n, for example, on the platform 510. In such an example, the identification device 240 may be within the communication range 250 of the various reading devices 340 within each of the packages 200n. By placing the identification device in this manner, each (or at least some) of the apparatuses within the packages 200n can then configure the communication modules 320 to operate in accordance with the particular communication protocol associated with the identification tag 240.

The above examples relate to embodiments where a communication module is configured based on the placement of an identification device in a proximity of a packaged product. In such an embodiment, the identification device can be a passive device that is itself unpowered. This can be achieved because the powered reading device within the package can send broadcast signals that generate an electromagnetic field sufficient to temporarily power the identification device. In other embodiments, the broadcast signals can come from a device that is exterior to the package. In this way, the device within the package can be passive so that it does not need to rely on a separate power supply.

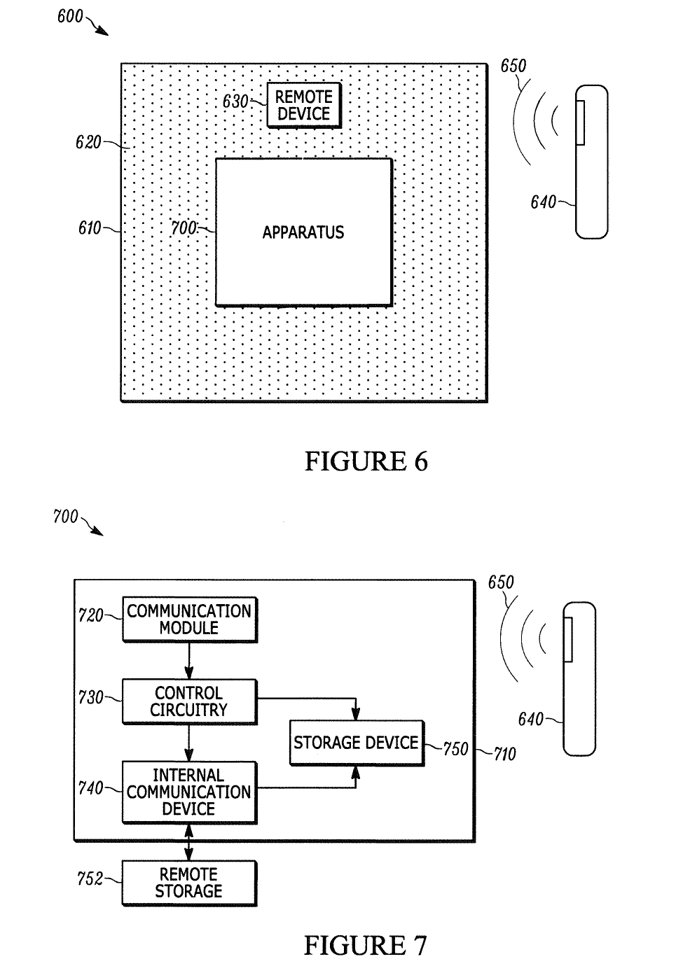

FIGS. 6-8 show examples of a packaged apparatus 600 that can be configured within the package by an exterior communication device. Specifically, FIG. 6 shows an apparatus 700 and a remote device 630 packaged within a package housing 610. Like the apparatus 300 shown in FIGS. 2-4, the apparatus 700 of FIG. 6 can take on a variety of forms, and includes a communication device that can be configured to communicate via a plurality of different communication signal protocols. In some formats, the apparatus 700 will be a movable barrier operator or similar device. The remote device 630 within the package housing 610 can be essentially the same as remote device 230, and can be used to communicate with the apparatus 700, in particular the communication module of the apparatus 700. The package 700 may include some packaging materials 720 that provide structural support or stability to the packaged products within the package.

An exterior communication device 640 actively broadcasts a communication signal 650 to the package 700. The signal 650 is configured to be detected by an internal communication device within the package 600, in particular, an internal communication device associated with the apparatus 700 that is distinct from the communication module that communicates with the remote device 630.

FIG. 7 shows a block diagram of an exemplary apparatus 700 that may be placed in the package 600. The apparatus 700 includes a communication module 720, control circuitry 730, an internal communication device 740, and a storage device 750. Unlike the apparatus 300 of FIG. 3, the apparatus 700 is shown without a separate internal power supply source. This is because the internal communication device 740 can be configured to operate without a separate power supply. However, it should be appreciated that some examples of the apparatus 700 could certainly operate with a separate power source equivalent to that of the power supply 345 of FIG. 3, which power source could be used to power one or more of the internal communication device 740, the storage device 750 and the control circuitry 730. The components of the apparatus 700 may be within an apparatus housing 710. The apparatus 700 may include additional components, including an additional power supply, such as an AC power supply connector, a DC power supply connector, a battery, or the like.

Like the communication device 320, communication module 720 can be a device that is capable of communicating wirelessly with other remote devices, such as remote device 730, and is capable of communicating via a variety of different communication or signal protocols. The control circuitry 730 is in communication with the communication module 720 and is capable of configuring the communication module to communicate at one or more particular communication protocols among the variety of communication protocols. The internal communication device 740 is similar to the reading device 340 of the embodiment of FIG. 3, and is in communication with the control circuitry and one or more storage devices, such as a local storage device 750 and a remote storage device 752. However, in this embodiment, the internal communication device 740 is configured to receive signals from communication sources outside of the package 600 (e.g., external communication device 640), rather than scanning for external devices by sending its own broadcast signals. In this way, the internal communication device 740, and the packaged apparatus 700 itself, may require a smaller power draw, and could possibly even operate without drawing power from any internal power sources within the package. This can allow the apparatus 700 to remain configurable within the package 600 for extended periods of time.

The internal communication device 740 may be a passive RFID tag that is powered by an electromagnetic field generated by the external communication device generating the signal 650. In this way, when the external communication device 640 (which may be in the form of a wand, gun, etc.) generates a signal directed at the internal communication device 740, the internal communication device generates power from the electromagnetic field sufficient to encode information onto the storage device 750. This information can include information pertaining to a particular communication protocol. When the apparatus is subsequently activated (e.g., by being plugged into an external power supply), the control circuitry will consult the storage device 750 and configure the communication module 720 accordingly.

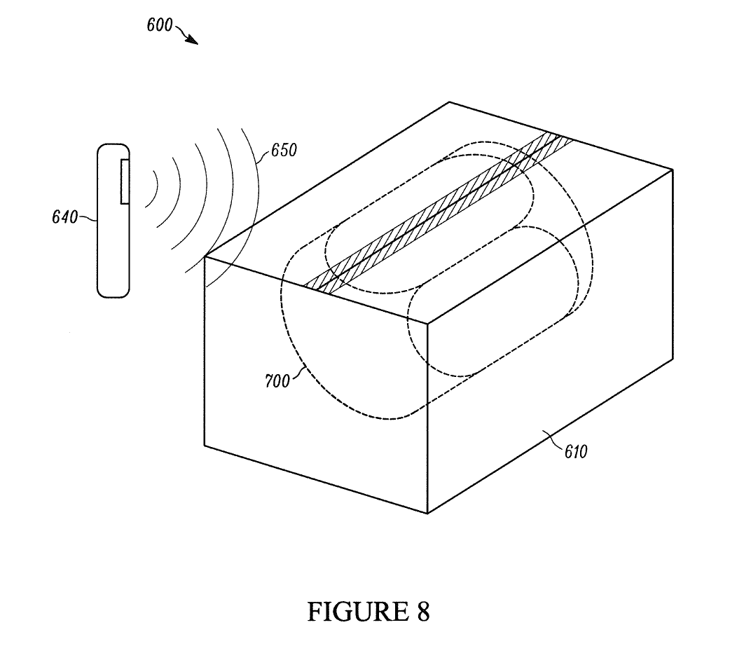

FIG. 8 shows an example of a package 600 in accordance with the examples described with respect to FIGS. 6 and 7. The package 600 includes an apparatus 700 (shown in broken lines) inside of a package housing 610, which in this embodiment is a box. An external communication device 640 (e.g., an active RFID transmitter wand) is waved on or around the package 600 exterior while transmitting a signal 650. The internal communication device 740 within the package 600 (which can be a passive RFID tag) detects the signal 650, and updates the storage device 750 with information provided by the signal 650, the information including information associated with a particular communication protocol. Upon setup of the apparatus, the control circuitry 730 can configure the communication module 720 of the apparatus to operate according to the particular communication protocol.

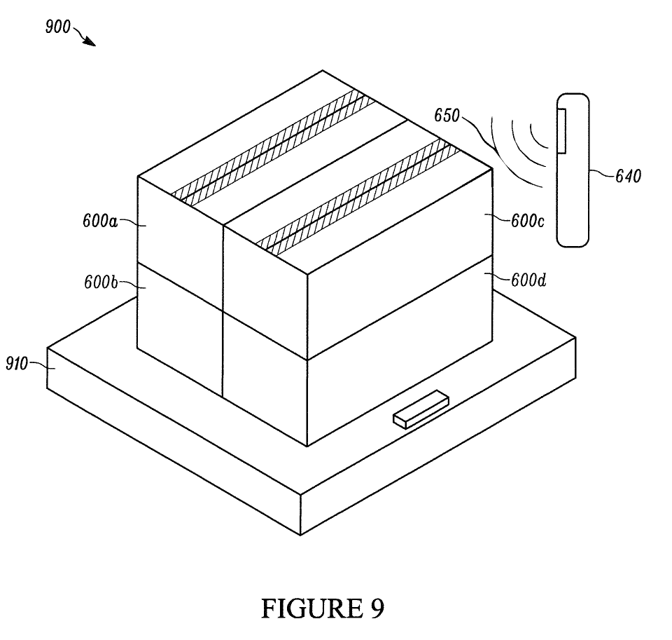

Like the embodiment described with respect to FIG. 5, the aforementioned example can also be employed for use across multiple packages, where multiple packages are placed in close proximity to one another, such as on a skid or pallet, or on a shelf or storage structure. In such a situation, it can be effective to configure the individual apparatuses collectively. FIG. 9 shows an example of a skid 900 comprising multiple packages 600n. In this example, four packages 600n, each of which contain similar or identical apparatuses (e.g., each package 600n contains the same product and model), are resting on a platform 910 or pallet. An external communication device 640 is waved about the skid 900 and transmits a signal 650 that can be detected by one or more of the packages 600 on the skid. The signal 650 comprises information pertaining to a particular communication protocol. Internal communication devices 740 within the packages 600 are adapted to detect the signal 650 and to respond by storing information pertaining to the particular communication protocol on a storage device.

In some embodiments docks or shipping facilities can utilize an exterior communication module 640 as a configuration transceiver to communicate with packages 600 as the packages are loaded onto trucks or other shipping vehicles. The configuration transceiver can automatically encode the internal communication devices 740 of the packages 600 with information relating to the communication protocol that corresponds with the protocols used in the geographic region that is the destination of the shipping vehicle.

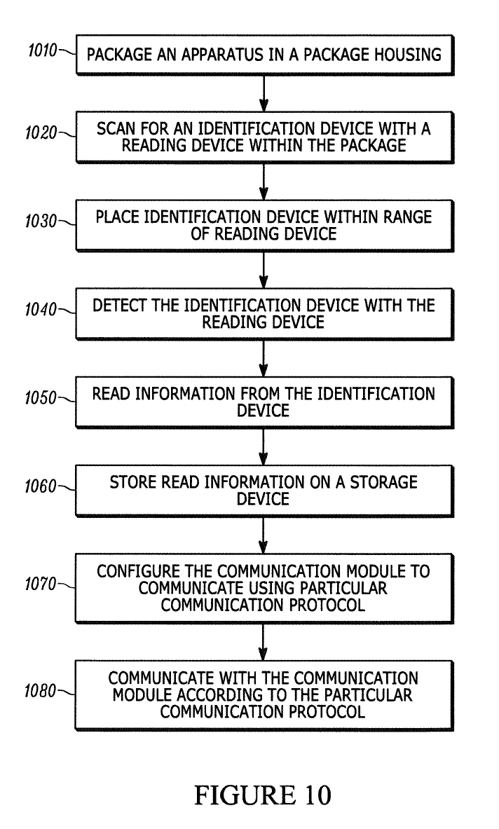

Certain aspects of this disclosure also relate to methods of configuring a product while it is within a package. In particular, some examples relate to methods of configuring packaged products having communication devices so that the communication devices communicate via a particular communication protocol, among a variety of communication protocols. FIG. 10 is a flow diagram for one such method 1000. In this method 1000, an apparatus is packaged 1010 within a package housing, such as a box or container. In some forms, the packaged apparatus may only be partially within the package housing, but at least a portion of the apparatus will be surrounded, enclosed, wrapped, enveloped, or otherwise located within the package housing. The apparatus has control circuitry, a reading device and a communication module, and the control circuitry is in communication with the reading device and communication module. The communication module is capable of communicating (e.g., to send and/or receive wireless communication signals) according to a plurality of different signal protocols. For instance, the communication module can be configured to communicate in each of a variety of different signal protocols that correspond to regulations or requirements defined by agencies in various geographic regions.

The reading device scans 1020 for an identification device within a communication range of the reading device. The scanning 1020 can involve periodically transmitting broadcast signals from the reading device. The broadcast signals are adapted to detect and communicate with identification devices positioned outside of the package, and the scanning may further include listening for responsive signals from such identification devices. The reading device may transmit broadcast signals more or less frequently depending on a variety of factors including but not limited to the available power supply for the reading device, the desired communication range of the reading device, the manner in which identification devices will be placed about the package within the communication range, and the size of the package. In some examples, the scanning 1020 includes transmitting the broadcasting signal once per hour, once every five minutes, once per minute, once every five seconds, once per second, or multiple times per second.

While the reading device scans 1020, an identification device is placed 1030 within the communication range of the reading device. The identification device is encoded with information associated with a particular signal protocol. For example, the identification device may include a storage device with information that identifies a particular communication protocol among a variety of different communication protocols in which the communication module is able to communicate. In some examples, the identification device is an RFID tag, (e.g., a passive RFID tag), and the reading device is an active RFID reader. In some examples, the identification device may be writable (e.g., it may be a read-write RFID tag) such that the information encoded on the device can be modified by another external communication (e.g., active RFID device) device. In this way, the step of placing 1030 an identification device relative to the package housing may include communicating with the read-write RFID tag with an external communication device to modify the information stored thereon.

Upon placement of the reading device within the communication range of the reading device, the reading device will detect 1040 the identification device and establish a two-way line of communication therebetween. Via this two-way line of communication, the reading device and the identification device can communicate and exchange information.

The reading device then reads 1050 information encoded on the identification device. The reading can include transferring the information encoded on the identification device and storing the information on a storage device associated with the reading device and/or the apparatus. For instance, the reading 1050 can include downloading information encoded on the identification tag.

The reading device may also store 1060 the downloaded information onto a local storage device that is a component of the reading device, or on a separate storage device that is in communication with the control circuitry of the apparatus. In some formats, the reading device may store 1060 the information on a remote storage device, such as a cloud storage device, which the reading device communicates with wirelessly, for example, through a network or other form of wireless communication. The storing 1060 may include writing over information previously stored on the storage device. For instance, where the reading device detects a new identification device, the reading device may then store 1060 information from the new identification device over previously stored information on the storage device.

The reading device may continue to scan for identification tags, and update the storage device with new or replacement information when the placement of a new identification device is detected. The reading device may also update the storage device when it detects that the information on the identification device has been changed or modified. For example, where the identification device is a writable device, and the writable device is modified or updated with information from an outside source, the reading device may detect the modification and update the storage device with the new information accordingly.

The control circuitry configures 1070 the communication module to operate in accordance with a particular protocol associated with the information most recently stored on the storage device. The configuring 1070 may occur immediately upon the reading 1040 of the information, or it may occur at some point later, such as when the apparatus is set up or installed for the first time. In some examples, the information stored on the storage device will include executable instructions for configuring a communication module. In other examples, the information on the storage device will merely identify a particular communication protocol, and the control circuitry will execute commands for configuring the communication module accordingly. For instance, the control circuitry may consult a lookup table that associates types of identification information with a particular set of configuration processes, and will execute the configuration process associated with the information stored on the storage device. The configuration 1070 will thus cause the communication module to transmit communication signals in accordance with the particular communication protocol associated with the information. The configuring 1070 may be performed repeatedly, as the information stored in the storage device is updated and/or modified.

Upon configuration of the communication module, the apparatus may be installed and used for operation. The communication module may then transmit 1080 a wireless communication signal from the communication module to a remote device via the particular communication protocol. For instance, the apparatus may be a movable barrier operator, and the communication module may be a component configured to communicate with remote devices like control units and sensors. In this manner, the communication 1080 may include sending or receiving signals from the remote devices in accordance with the particular communication protocol.

The method 1000 may be performed simultaneously with respect to a plurality of similar apparatuses packaged within separate package housings and placed on a skid, each of the similar apparatuses having separate control circuitry, a separate reading device, and a separate communication module adapted to communicate according to a plurality of different signal protocols. In this manner, the placement 1030 of the identification device may involve placing the identification device within a communication range of each of the separate reading devices of the similar apparatuses placed on the skid. The scanning 1020 may also include scanning, with multiple reading devices of the various packages similar apparatuses, for the identification device. Upon detection 1040 of the identification device, the individual reading devices may each read 1050 the information from the identification device and then store 1060 the information on individual storage devices within the individual packages. Upon setup of each of the individual similar apparatuses, the individual control circuits will configure 1070 the individual communication modules based on the information stored on the individual storage devices.

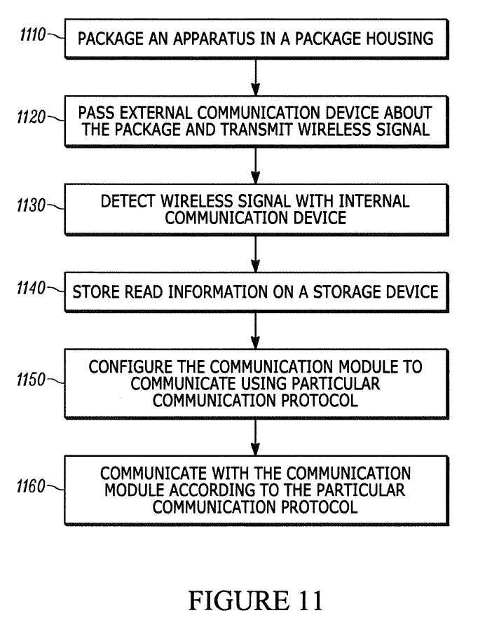

FIG. 11 is a flow diagram for another method 1100 that involves configuring a communication module of a packaged apparatus by transmitting a signal from outside the package. The method 1100 includes packaging 1110 an apparatus within a package housing. The packaged apparatus includes control circuitry, an internal communication device, and a communication module adapted to communicate according to a plurality of different signal protocols. The internal communication device may be an active or passive communication device (e.g., a passive RFID tag).

An external communication device is then passed 1120 about the package. This passing 1120 can involve waving a transmitting wand about a package or “shooting” a signal (e.g., a radio signal) from a transmitting device at the package. The passing 1120 should bring the external communication device close enough to the package so that the internal communication device within the package can detect the signal. The external communication device may be, for example, an active RFID device.

The internal communication device detects 1130 the wireless signal transmitted from an external communication device. The wireless signal includes information associated with a particular signal protocol. The internal communication device stores 1140 the information associated with the particular signal protocol on a data storage device associated with the apparatus. The storage 1140 may be performed repeatedly as the internal communication device detects subsequent signals from an external communication device.

The control circuitry configures 1150 the communication module to operate in accordance with a particular protocol associated with the information most recently stored on the storage device. The configuration 1150 may occur in the same manner as the configuration 1070 described with respect to the method 1000 of FIG. 10. The configuration 1150 thus causes the communication module to transmit communication signals in accordance with the particular communication protocol associated with the information.

The configuring 1150 may be performed repeatedly, as the information stored in the storage device is updated and/or modified. Upon configuration of the communication module, the apparatus may be installed and used for operation. The communication module may then transmit 1160 a wireless communication signal from the communication module to a remote device via the particular communication protocol. For instance, the apparatus may be a movable barrier operator, and the communication module may be a component configured to communicate with remote devices like control units and sensors. In this manner, the communication 1160 may include sending or receiving signals from the remote devices in accordance with the particular communication protocol.

As with method 1000, method 1100 may be performed simultaneously with respect to a plurality of packages on a skid. In this manner, the external communication device may broadcast a single signal that is detected simultaneously by each of the internal communication devices in each of the individual packages, or it may involve repeatedly transmitting separate broadcast signals, each aimed at a separate package on the skid. More particularly, the method can include placing 1100 one or more packaged apparatus on a skid along with at least one other packaged apparatus, the at least one other packaged apparatus comprising separate control circuitry, a separate internal communication device, and a separate control module adapted to communicate according to the plurality of different signal protocols. The passing 1120 can include bringing an external communication device within proximity of the skid, and transmitting one or more broadcast signals such that each of the internal communication devices in the individual packages on the skid detect 1130, and respond by storing 1140 information in the signal associated with the particular signal protocol on a separate data storage device. Upon setup of each of the individual similar apparatuses, the individual control circuits will configure 1150 the individual communication modules based on the information stored on the individual storage devices.

This application describes wireless communication devices (e.g., radio transceivers, routers, etc.) that are capable of communicating via a variety of different communication protocols, and techniques for configuring those wireless communication devices so that they operate at a particular communication protocol (or in some cases, a subset of particular protocols). The described techniques can be applied to configure products after the products have been packaged. In this manner, the communication devices can be manufactured and packaged in bulk, taken to distribution centers, and then configured (in the package) so that the communication device communicates using a particular communication protocol (or subset of particular protocols) that is consistent with the protocols used and allowed in the region where the package is being shipped. The described packaged products and related methods allows for similar products to be manufactured and packaged in similar manners, without having to separate products based on their destination region prior to packaging. The described products and techniques also helps alleviate any harm that can result from accidentally shipping improperly configured products to a particular region.

The present disclosure describes preferred embodiments and examples of a configurable packaged apparatus, and related methods of configuration. Those skilled in the art will recognize that a wide variety of modifications, alterations, and combinations can be made with respect to the above described embodiments without departing from the scope of the invention as set forth in the claims, and that such modifications, alterations, and combinations are to be viewed as being within the ambit of the inventive concept. For instance, reference to a skid or pallet includes other ways of commercially shipping multiple boxes together, including, for example, placing multiple boxes in a crate. In addition, it should also be understood that features of one embodiment may be combined with features of other embodiments to provide yet other embodiments as desired. All references cited or discussed in the present disclosure are hereby incorporated by reference in their entirety.

1) A method of configuring a wireless communication device, the method comprising:
communicating wirelessly between a first wireless communication device outside a package and a second wireless communication device installed within an apparatus stored within the package, wherein the apparatus is configured to communicate wirelessly according to any one of a plurality of different wireless communication protocols;
setting, based on the communicating between the first wireless communication device and the second wireless communication device, the apparatus to communicate wirelessly using one of the plurality of different wireless communication protocols.

2) The method of claim 1, wherein the communicating comprises scanning by the second wireless communication device for a signal transmitted by the first wireless communication device.

3) The method of claim 1, further comprising storing by the second wireless communication device in a data storage device information indicating one of the plurality of different wireless communication protocols.

4) The method of claim 3, wherein the storing comprises writing over the information indicating the one of the plurality of different wireless communication protocols with information indicating a different one of the plurality of different wireless communication protocols.

5) The method of claim 3, wherein the setting comprises configuring, with control circuitry of the apparatus, a communication module of the apparatus based on the information stored in the data storage device.

6) The method of claim 3, wherein the first wireless communication device is an RFID tag, and the second wireless communication device is an active RFID reader.

7) The method of claim 6, wherein the RFID tag is a passive RFID tag.

8) The method of claim 6, wherein the RFID tag is a read-write RFID tag, and further comprising communicating with the read-write RFID tag with an external communication device to modify the information indicating one of the plurality of different wireless communication protocols and encoded on the read-write RFID, wherein the setting comprises reading and storing the modified information from the read-write RFID tag onto the RFID tag.

9) The method of claim 1, further comprising transmitting a wireless communication signal from a communication module of the apparatus to a remote device via the one of the plurality of different wireless communication protocols.

10) The method of claim 1, further comprising the first wireless communication device communicating with a plurality of second wireless communication devices installed in different apparatuses stored within different packages placed on a skid.

11) The method of claim 10, wherein each of the similar apparatuses having separate control circuitry, a separate reading device, and a separate communication module adapted to communicate according to a plurality of different signal protocols, and
wherein the step of placing the identification device involves placing the identification device relative to the skid so that the identification device is in within a communication range of each of the separate reading devices of the similar apparatuses placed on the skid.

12) The method of claim 11, wherein the communicating step further comprises:
scanning, with the separate reading devices, for an identification device within a communication range of the separate reading device,
reading with the separate reading devices information encoded on the identification device associated with a particular signal protocol, and
wherein the setting step further includes configuring with control circuitry of the apparatus the separate communication module of the at least one similar apparatus to communicate according to the particular signal protocol, wherein the particular signal protocol is among the plurality of different wireless communication protocols.

13) The method of claim 1, wherein the apparatus further comprises a movable barrier operator adapted to be installed near an entryway and to control movement of a barrier between open and closed positions with respect to the entryway, and wherein the movable barrier operator comprises a communication module is adapted to communicate with a wireless barrier operator controller.

14) The method of claim 1, wherein the communicating further comprises transmitting, with the first communication device, a wireless signal to the second communication device.

15) The method of claim 14, wherein the transmitting comprises pointing the first communication device at the package and activating a trigger to transmit a radio signal.

16) The method of claim 1, wherein the first communication device is a read-write RFID tag adapted to write over information previously encoded on the RFID tag, and wherein the setting step comprises encoding the RFID tag with information pertaining to the one of the plurality of different wireless communication protocols.

17) The method of claim 1, further comprising:
placing the package on a skid along with at least one other packaged apparatus, the at least one other packaged apparatus comprising separate control circuitry, a separate internal communication device, and a separate control module adapted to communicate according to the plurality of different signal protocols;
detecting, with the internal communication device of the at least one other packaged apparatus, a signal from the external communication device, the signal comprising information associated with the particular signal protocol;
storing the information associated with the particular signal protocol on a data storage device associated with the at least one other packaged apparatus; and
configuring the communication module of the at least one other packaged apparatus to communicate according to the particular signal protocol.

18) The method of claim 15, further comprising transmitting a wireless communication signal from the communication module to a remote device via the particular communication protocol.

19) The method of claim 15, wherein the apparatus further comprises a movable barrier operator adapted to be installed near an entryway and to control movement of a barrier between open and closed positions with respect to the entryway, and wherein the communication module is adapted to communicate with a wireless barrier operator controller.

20) A package comprising:
a package housing;
an apparatus packaged within the package housing, the apparatus comprising:
a communication module adapted to communicate in accordance with a plurality of different communication protocols;
control circuitry in communication with the communication module, the control circuitry adapted to control the communication module to communicate in accordance with at least one of the plurality of different communication protocols; and
a reading device in communication with the control circuitry;
wherein the reading device is adapted to detect an identification device within a communication range of the reading device, the identification device being encoded with information pertaining to a particular signal protocol,
wherein the reading device is adapted to receive information from the identification device and to store the information on a data storage device associated with the apparatus, the stored information comprising the information associated with the particular signal protocol, and
wherein with the control circuitry is adapted to control the communication module to communicate using the particular signal protocol associated with the information stored on the data storage device.

21) The package of claim 20, wherein the reader is adapted to detect the identification device by periodically sending a signal adapted to detect the identification device within a communication range of the reading device.

22) The package of claim 21, wherein the identification device is an RFID tag, and wherein the reading device is an RFID reading device.

23) The package of claim 22, wherein the RFID tag is a passive RFID tag.

24) The package of claim 23, wherein the apparatus comprises a movable barrier operator adapted to be installed near an entryway and to control movement of a barrier between open and closed positions with respect to the entryway,
wherein the control circuitry is in communication with, and is adapted to effect operation of, the movable barrier operator, and
wherein the communication module is adapted to communicate with a wireless barrier operator controller.

25) A skid comprising a plurality of the packages of claim 20 and an identification device encoded with information pertaining to a particular signal protocol within the communication range of at least one of the packages.

26) The skid of claim 25, wherein the identification device is within the communication range of the reading devices of at least two of the packages, and
wherein the control circuitry of the apparatus of the at least two packages is adapted to control the communication modules of the respective apparatuses to communicate according to the particular signal protocol.

27) A package comprising:
a package housing;
an apparatus packaged within the package housing, the apparatus comprising:
a communication module adapted to communicate in accordance with a plurality of different communication protocols;
control circuitry in communication with the communication module, the control circuitry adapted to control the communication module to communicate in accordance with at least one of the plurality of different communication protocols;
an internal communication device in communication with the control circuitry, the internal communication device adapted to detect, from within the package housing, signals transmitted from an external communication device exterior to the package housing; and
a data storage device in communication with the internal communication device and the control circuitry,
wherein the internal communication device is adapted to store information pertaining to a particular signal protocol on the data storage device based at least in part on the signals detected from the external communication device, and
wherein with the control circuitry is adapted to control the communication module to communicate using the particular signal protocol based at least in part on the information stored on the data storage device.

28) The package of claim 27, wherein the apparatus comprises a movable barrier operator adapted to be installed near an entryway and to control movement of a barrier between open and closed positions with respect to the entryway,
wherein the control circuitry is in communication with, and is adapted to effect operation of, the movable barrier operator, and
wherein the communication module is adapted to communicate with a wireless barrier operator controller.

29) The package of claim 28, wherein the data storage device is adapted to write over previously stored information associated with a particular signal protocol.

30) The package of claim 29, wherein the internal communication device is a read-write RFID tag adapted to write over information previously encoded on the RFID tag, and wherein the data storage device is a component of the read-write RFID tag.

31) A skid comprising a plurality of the packages of claim 27.

32) The skid of claim 31, wherein the identification device is within the communication range of at least two of the packages, and
wherein the control circuitry of the individual apparatuses of the at least two packages is adapted to control the communication modules of the respective apparatuses to communicate according to the particular signal protocol.
